(19) United States
(12) Patent Application Publication
(10) Pub. No.: US 2006/0230142 A1
(43) Pub. Date: Oct. 12, 2006

(54) Contents sharing apparatus and contents sharing method

(76) Inventors: Takayuki Yamamoto, Fujisawa (JP); Hiromichi Ito, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/398,649

(22) Filed: Apr. 6, 2006

(30) Foreign Application Priority Data
Apr. 8, 2005 (JP) 2005-111511
Jan. 27, 2006 (JP) 2006-018366

(51) Int. Cl. G06F 15/173

(52) U.S. Cl. 709/224

(57) ABSTRACT

When a content is playbacked via a network, if a transmission-sided terminal of the content is under stopping condition, then a lengthy time is required until the content is playbacked. When an activation time of a recorder is measured and contents are recorded on this recorder, a content corresponding to the activation time is copied to another recorder so as to be shared by the own recorder and another recorder. In the case that the content is playbacked via the network, the content held in the own recorder is firstly playbacked, and when the recorder holding the content is activated, so that the content can be transmitted, the own recorder directly receives the content from the recorder holding the content to playback the received content.

### INCORPORATION BY REFERENCE

The present application claims priority from Japanese patent application No. JP2005-111511 filed on Apr. 8, 2005 and No. JP2006-018366 filed on Jan. 27, 2006, the content of which are hereby incorporated by reference into this application.

### BACKGROUND OF THE INVENTION

The present invention is related to a contents sharing system and a contents sharing apparatus, which share contents via networks in a comfortable manner.

Generally speaking, the following methods for using VTRs (Video Tape Recorders) and DVD (Digital Versatile Disc) recorders are known. That is, while these VTRs and DVD recorders have been popularized in home use, these recorders mainly record/playback broadcasting waves, or reproduce contents rented/purchased from rental video shops and video selling shops, and then, output pictures/voice to televisions.

Since prices of these recorders and televisions are rapidly lowered in connection with popularization thereof, generally speaking, plural sets of these recorders/televisions are owned within a single home. More specifically, such products have been marketed in home use, by which recorders are operated from televisions located apart from these recorders over several, or more meters via communications defined by communication standards of IEEE 1394, specific standards of venders, and the like.

On the other hand, since the Internet has been popularized, in-home IP (Internet Protocol) networks are usually used.

Under such a circumstance, trials for transmitting/receiving AV (Audio Visual) contents on IP networks within homes have been performed. In particular, since the standard of DLNA (Digital Living Network Alliance) has been conducted, contents shared by home appliances via an in-home IP network may be realized.

In-home contents sharing methods are such technical ideas that plural sets of HDD recorders and televisions provided in a single home are mutually shared, or commonly used by being connected to each other via a network. Based upon this technique, contents can be shared only under IP communicatable network environment. For instance, contents recorded on a recorder installed in a bed room can be simply playbacked in a living room.

However, in such a case that a content is playbacked via a network by employing a network operable contents recorder, a summation time made by a time required until the content of the transmission source is playbacked, a time required for transferring the content via the network, and a time required for receiving the content and for playbacking the received content constitutes a waiting time for a user. As a result, a reaction time is very slow, for example, as compared with that of an analog television.

On the other hand, since energy saving intentions have been recently increased, waiting power may cause a problem for not only recorders but also other appliances. Therefore, when electric appliances are not operated, these appliances must be set in sleep modes. In sleep modes, only recording reservation functions are activated, while CPUs (Central Processing Units) are activated under necessary minimum power.

In order to acquire contents from a WOL (Wake On LAN) operable recorder in a sleep mode via a network, a specific IP packet usually called as a “magic packet” must be transmitted to a recorder having contents so as to activate this recorder. Thereafter, the contents can be acquired from the activated recorder.

Generally speaking, activation times of recorders are approximately several seconds to several tens of seconds. An operation for activating network functions corresponds to a process operation requiring a lengthy time. For instance, in particular, when a DHCP (Dynamic Host Configuration Protocol) server is utilized, usually, 10 seconds, or more seconds of activation times are necessarily required. In other words, in order to acquire a content from a recorder in a sleep mode, a time duration for several tens of seconds is required.

To solve such a problem, normally caching means, or means for downloading (or receiving) data in advance are utilized.

A caching technique corresponds to such a general-purpose method that while either a portion or all of data which have been once used is held, when the same data is used, this data is derived from a cache, so as to improve a speed.

As an example of reading contents in advance, JP-A-2003-009113 describes such a method for reading contents in advance to playback the read contents.

### SUMMARY OF THE INVENTION

A cache system is generally employed in CPUs and Web browsers. Although this method becomes very effective in the case that a hit rate of the cache is high, a statistical process operation is required in the cache in order to improve the hit rate. Thus, there is an essential drawback that all of contents must be cashed in order that a small number of contents are hit to the cache.

In other words, in order to acquire a content from a recorder under sleep condition at a high speed by employing the cache method, all of the contents which have already been playbacked must be held. Also, since a cache is not present for a content which has not yet been playbacked, this content cannot be acquired at a high speed.

To solve such a problem, the method for downloading the contents before the user operation has been realized in the data downloading operation in advance reading. The data advance-reading downloading operation implies a method for previously downloading such a data which is predicable to be subsequently downloaded (acquired).

For instance, a portion of high-speed software of Web browsers has employed such a method for acquiring contents of a link destination before a user operation by utilizing this advance-reading method.

As to this advance reading method, if the next user operation can be correctly predicted, then this advance reading method may constitute the very effective means. In this method, the larger the information inputted by the user is increased, the easier the next user operation is predicted. Also, generally speaking, as to Web browsing operation, since there is a certain time after a content has been acquired until a next operation is commenced, it is effective that a content is read in advance so as to be downloaded during this time duration.

However, in the advance reading method, the content advance reading operation is not carried out just after the apparatus is activated by the user. Therefore, there is a demerit that this advance reading method cannot be applied. Also, there is another demerit that a large part of network band is consumed in order to perform the advance reading operation. In other words, when the advance reading method is utilized, an operation-sided terminal previously activates a recorder under sleep mode, and must previously acquire contents. This method owns the following problems: That is, since other appliances are unnecessarily activated so as to acquire the contents, the power consumption is increased. Also, the storage areas of the memory and the hard disk are largely consumed.

As a derivative system for the advance reading method, when the user activates the operation terminal, all of other recorders are activated. As a result, since the activation times can be omitted, the contents can be acquired via the network within a short time. However, there is another problem that power consumption is increased by a total number of these recorders.

Although such a method may be conceived in which only the network function is activated in the sleep mode, it is not desirable to continuously operate the network function which is not essentially used.

That is to say, a problem to be solved is given as follows: In a network operable contents recorder corresponding to a contents sharing apparatus, when a content is playbacked via the network, if a transmission-sided terminal of the content is set in sleep mode, then a lengthy time is required until the content is playbacked.

To solve the above-described problems, the present invention is featured by that while an activation time of a recorder is measured, when a content is recorded on this recorder, a content for the activation time is also copied to another recorder in order to share the copied content by these recorder. The present invention is featured by such a contents sharing apparatus having a function for sharing contents via a network, comprising: means for holding a time required to activate the contents sharing apparatus; means for previously transmitting a content corresponding to the time for the activation to another apparatus; means for forming and updating indexes of contents held in the contents sharing apparatus; and means for sharing the indexes with another contents sharing apparatus, in which the content equivalent to the time required for the activation is previously transmitted to another contents sharing apparatus.

Also, the contents sharing apparatus of the present invention is comprised of: means for measuring time for activating the contents sharing apparatus; and means for forming and updating indexes of the content equivalent to the time required for the activation, in which a network address of content in the indexes.

Also, in the present invention, the indexes of the content corresponding to the time required for the activation are contained in an area where the indexes of the contents held in the contents sharing apparatus are expanded so as to be managed.

Also, in the present invention, in order to previously share the content corresponding to the time required for the activation with another apparatus, activation time is contained in the indexes, and another apparatus previously shares the contents by requesting the content corresponding to the activation time.

Also, the present invention is featured by such a contents sharing apparatus having a function for sharing contents via a network, comprising: means for acquiring indexes from another contents sharing apparatus; means for previously acquiring a portion of contents from another contents sharing apparatus; and means for acquiring a continuation of contents which have been previously acquired from another contents sharing apparatus having contents, in which when a content designated by the indexes is playbacked, the previously acquired content is playbacked, and a continuation of the contents subsequent to the previously acquired content is playbacked.

Also, in the present invention, a portion of the previously acquired contents corresponds to such a content which is indicated as a content which should be previously acquired in the indexes of the contents shared by the contents sharing apparatus. Also, a length corresponding to a content activation time acquired from the contents sharing apparatus is designated while the contents are acquired, so that a portion of the contents is previously acquired.

Also, in the present invention, when the contents are playbacked, an activation of another contents sharing apparatus is instructed, the previously acquired content is playbacked, and a continuation of the contents subsequent to the previously acquired content is playbacked.

Also, a contents sharing method, according to the present invention, is featured by that in order to share indexes of contents by another contents by another contents sharing apparatus, the contents sharing method is comprised of: a step for forming, or updating indexes of contents held in the contents sharing apparatus in order that the indexes of the contents are shared by another contents sharing apparatus; and a step for previously transmitting a content corresponding to an activation time of the contents sharing apparatus, in which contents corresponding to the indexes are transmitted.

Also, a contents sharing method, according to the present invention, is featured by comprising: a step for previously acquiring a portion of the contents from another contents sharing apparatus; a step for designation a content which should be playbacked based upon indexes of contents held in the contents sharing apparatus so as to instruct a playback operation of the content; a step for playbacking the content previously acquired in response to the instruction of the playback operation; and a step for acquiring a continuation of the previously acquired content from another contents sharing apparatus having the content which should be playbacked, in which a continuation of the content subsequent to the previously acquired content is playbacked.

A recorder of the present invention previously shares a content for a time required to activate a server-sided recorder. As a result, there is such an effect that in a time period until the server-sided recorder is activated, a content stored in a client-sided recorder is used to be playbacked. When the server-sided recorder is activated, the content is transmitted via a network, so that the content can be playbacked, and the client-sided recorder can immediately start to playback the content in response to the instruction for playbacking the content designated by the indexes.

Also, in a recorder according to another mode of the present invention, a content for a time required to activate the server-sided recorder is previously stored in another recorder. As another recorder among recorders which are connectable to the network, such a recorder whose activation time ratio is large is employed. Otherwise, a recorder whose activation time is short is employed. The client-sided terminal uses the content stored in another recorder to playback this content for a time period until the server-sided recorder into which the content has been stored is activated. When the server-sided recorder is activated, the client-sided terminal can playback the contents transmitted via the network. As a result, there is another effect that even if a portion of the content is not stored on the client side, the playback of the contents can be immediately started.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram for showing an entire arrangement of a contents sharing apparatus according to a first embodiment of the present invention.

FIG. 2 is a flowchart for explaining flow operations executed until quick-playback content is shared in the contents sharing apparatus of FIG. 1.

FIG. 3 is a flowchart for describing flow operations in the case that content is playbacked.

FIG. 4 is a flowchart for explaining flow operations for measuring activation time.

FIG. 5 is a diagram for explaining indexes.

FIG. 6 is a display example for selecting an index.

FIG. 7 is a flowchart for indicating, in detail, forming operation of a continuous content request.

FIG. 8 is a diagram for explaining the continuous content request.

FIG. 9 is a diagram for showing a flow of data when contents and quick-playback content are playbacked.

FIG. 10 is a diagram for representing a relationship among entire content, quick-playback content, and continuous content.

FIG. 11 is a diagram for showing a relationship among entire content, quick-playback content, and continuous content in the case that a copy restriction is made.

FIG. 12 is a flowchart for showing operations executed in the case that contents are deleted on the side of a server.

FIG. 13 is a schematic diagram for showing an entire arrangement of a contents sharing apparatus according to a second embodiment of the present invention.

FIG. 14 is a flowchart for explaining basic flow operations executed in the contents sharing apparatus of FIG. 12.

FIG. 15 shows an example of a table for indicating selected results of a quick-playback contents holding recorder.

FIG. 16 is a flowchart for describing flow operations in the case that contents are playbacked.

FIG. 17 is a diagram for explaining indexes.

FIG. 18 is a basic flowchart corresponding to stopping of a playback operation, and restarting of the playback operation.

FIG. 19 is an explanatory diagram for explaining a list of quick-playback contents corresponding to stopped appliances.

FIG. 20 is a diagram for showing a relationship between the entire content and the quick-playback content.

### DESCRIPTION OF THE EMBODIMENTS

Referring now to drawings, various embodiments of the present invention will be described.

### First Embodiment

A contents sharing apparatus according to a first embodiment of the present invention will now be described.

An object of the present invention is that while a client playbacks contents of a server via a network, a time duration required to select an index of a content to be playbacked and to thereafter playback pictures thereof by the client is shortened. This object is achieved with a minimum use amount of a client-sided storage area.

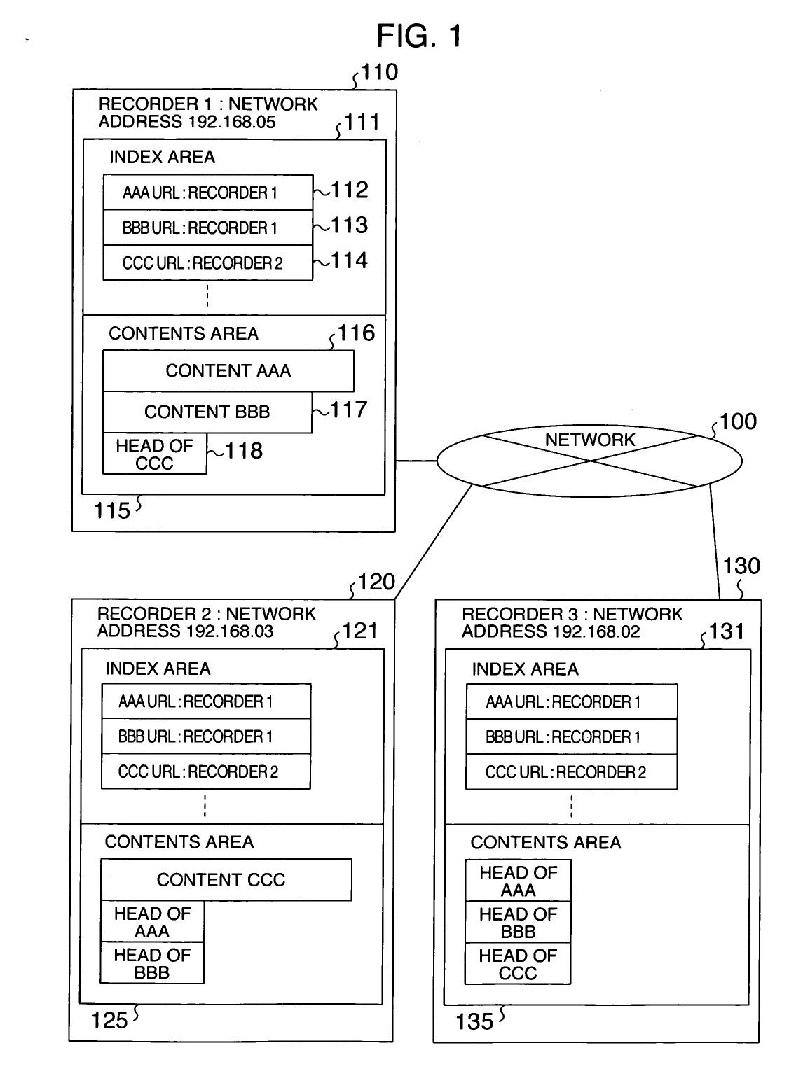

FIG. 1 is an entire diagram for showing a contents sharing apparatus according to a first embodiment of the present invention. Reference numerals 110, 120, 130 indicate recorders which share, or commonly use contents via a network 100. It should be noted that contents may cover recorded TV programs, recorded movies, photographs taken by users, music downloaded via networks, music copied from purchased CDs (Compact Discs), and the like. Also, contents may cover data indicative of details of own contents such as program information. In order to share contents, both an index area 111 and contents area 115 are provided in a recording area.

A contents area corresponds to an area for recording therein contents. For instance, in the case that a TV program is recorded, this TV program is recorded in this contents area. An index area corresponds to an area for holding a title and a detail of a content, and a URL (Uniform Resource Locator) indicative of a location on a network as an index. Alternatively, all of recorders which are connected to a network may have the same indexes in synchronism with these indexes.

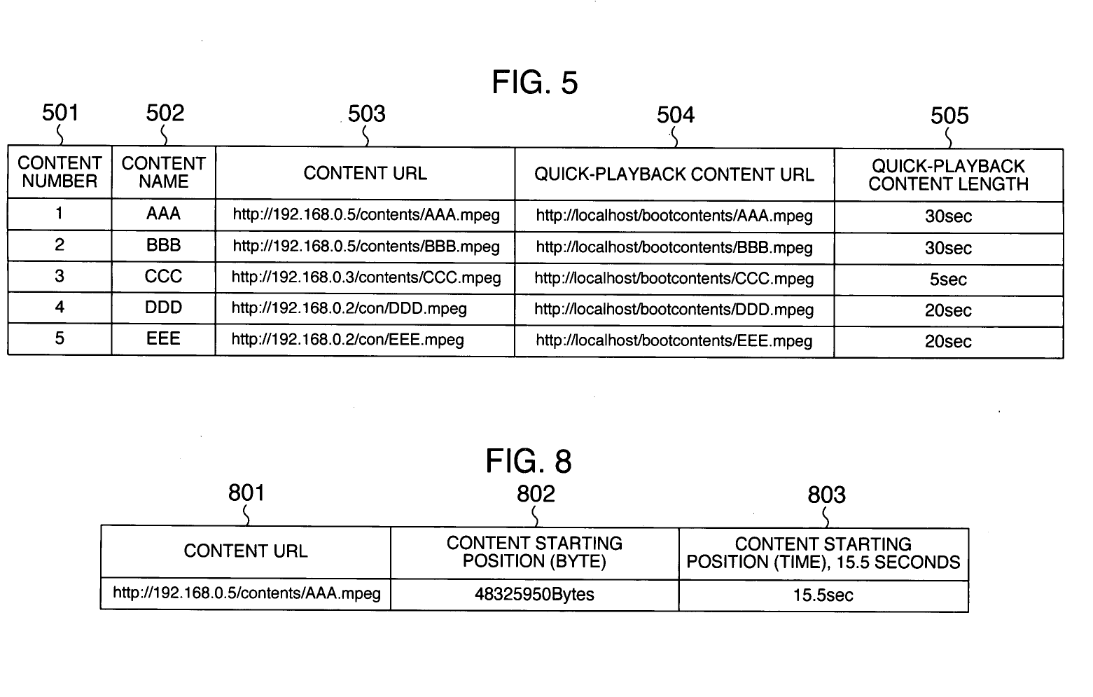

It should be understood that FIG. 5 shows an example of indexes.

Reference numerals 112 to 114 indicate indexes which show “URLs”, namely locations of content AAA, content BBB, and content CCC. For instance, in the index 112, it can be seen that the content AAA can be acquired from the recorder 1. It should also be noted that the URL of 112 is simply expressed, and alternatively may be represented in such a hierarchical form as a generally used URL. Also, a file name and other information may be alternatively described.

Numerals 116 and 117 show contents. Numeral 118 indicates a quick-playback content which is a feature of the present invention. It should also be understood a quick-playback content corresponds to such a content held on the side of a client, which is immediately started to be playbacked when a user instructs a playback operation on the side of the client. A quick-playback content length equal to a length of a quick-playback content is set to be longer than a time until a preparation of a content transmission on the side of a server is accomplished.

It should also be understood that a server side corresponds to such a side for holding contents, whereas a client side corresponds to such a side for playbacking contents. For example, in FIG. 1, as to the content AAA, the recorder 1 corresponds to the server side, whereas both the recorder 2 and the recorder 3 correspond to the client side, which may be similarly applied to the content BBB.

As to the content CCC, the recorder 2 corresponds to the server side, whereas both the recorder 1 and the recorder 3 correspond to the client side.

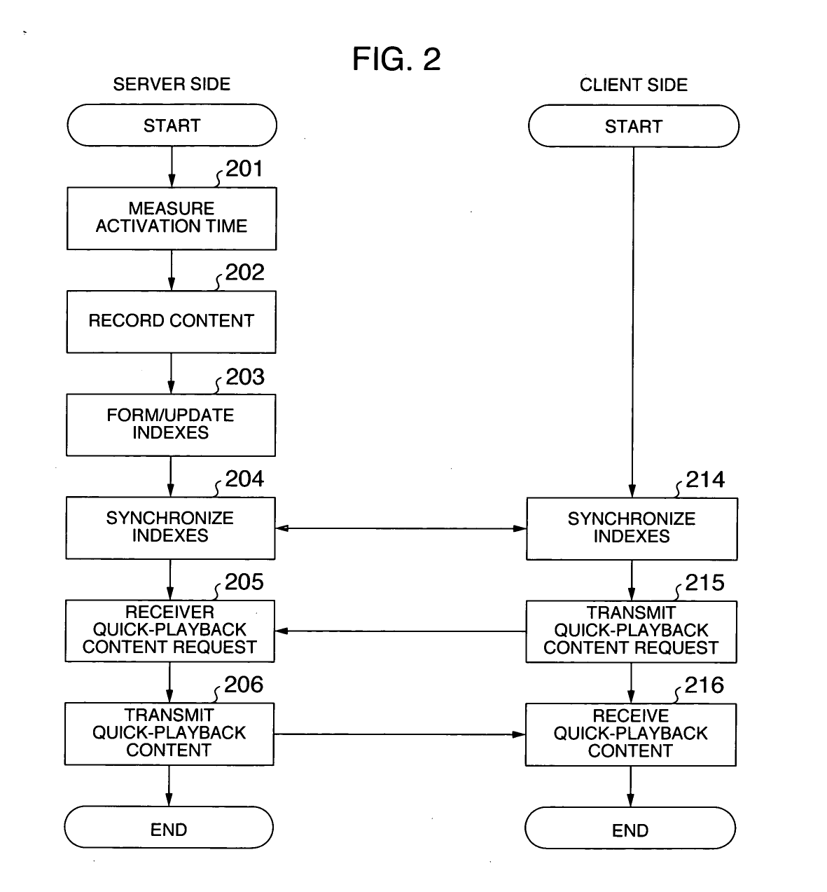

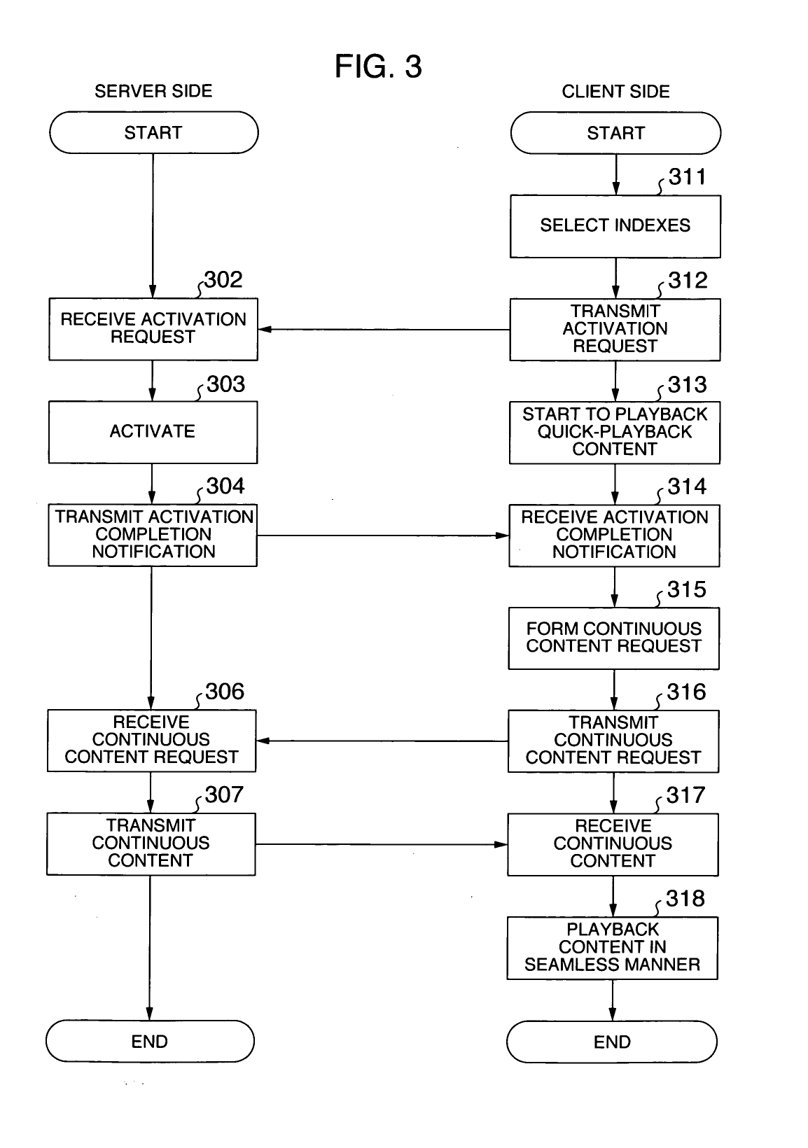

FIG. 2 and FIG. 3 are flowcharts for explaining operations of the contents sharing apparatus of the first embodiment of the present invention. FIG. 2 shows flow operations until the client side completes to receive a quick-playback content. FIG. 3 indicates flow operations in the case that the content is playbacked.

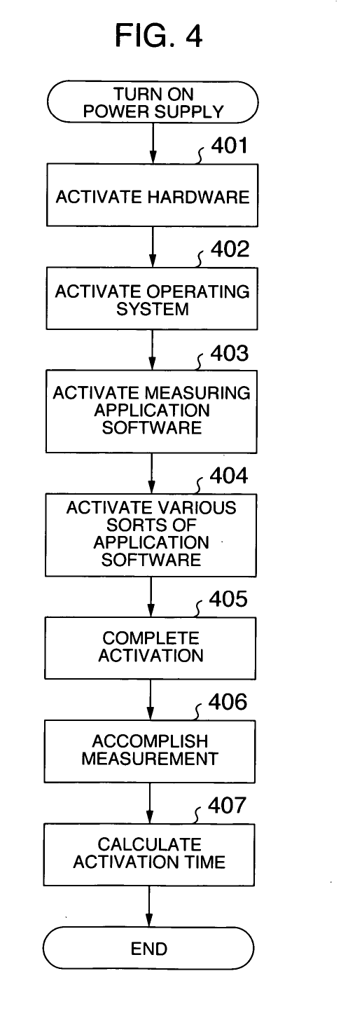

A first description is made of flow operations until the quick-playback content is shared with reference to the flowchart of FIG. 2. On the server side, when a process operation is commenced by turning ON a power supply, an activation time required by that a recorder is activated is measured (step 201). The content of step S201 will be explained in detail in FIG. 4. Also, the present operation of step 201 need not be executed every time when the power supply is turned ON.

Next, the server side records pictures of contents (step 202). This process operation is similar to the normal contents picture recording function of a recorder, for instance, picture recording operations of a TV program. Next, the server side forms indexes of the contents (step 203). In the case that indexes have already been prepared, the indexes may be alternatively updated.

Numeral 112 of FIG. 1 and FIG. 5 show an example of indexes of contents. When the indexes are formed/updated, the server side synchronizes the contents with the client side (steps 204 and 214). Timing at which a synchronization of indexes occurs need not always be defined just after the indexes are formed, but may be defined in a periodic manner, or after a certain amount of indexes to be synchronized is stored, or may be defined at a predetermined time.

Also, there is another case that a client side becomes a server side, as viewed from another content. As a result, in this case, triggering of a synchronization is performed from the client side. In a synchronization, indexes are copied in such a manner that the indexes of all of recorders become equal to each other. Alternatively, other synchronizing methods may be conducted in response to a purpose.

For instance, in such a case that the content CCC are not wanted to be playbacked by the recorder 3, it is so arranged that both the recorder 1 and the recorder 2 do not provide the indexes of the content CCC to this recorder 3. As a result, since the recorder 3 does not know the presence of the content CCC, the recorder 3 cannot playback from the indexes.

Next, the client side transmits a request of quick-playback content (step 215). When a URL of the quick-playback content is described in the indexes, the client side executes the request of the quick-playback content. When the server side receives the request of the quick-playback content (step 205), the server side transmits a content of a quick-playback content length calculated from the activation time measurement, as a quick-playback content (step 206). The client side receives the quick-playback content, and stores this received content in the content area (step 216).

Next, flow operations executed in the case that contents are playbacked will now be explained with reference to FIG. 3.

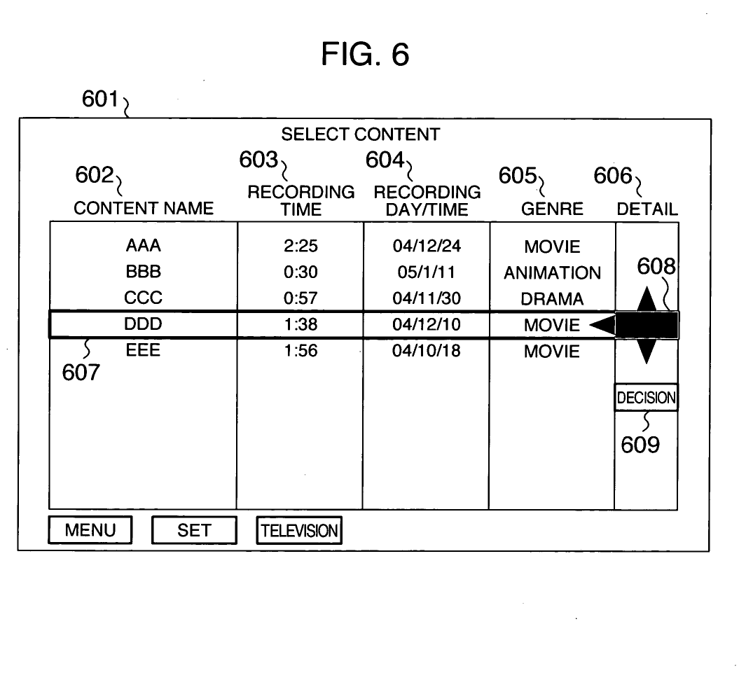

A user selects indexes by employing, for example, an operation screen view as shown in FIG. 6 on the client side (step 311). As a result, the client side transmits an activation request to the server side (step 312). Alternatively, the activation request may also have a confirmation of an activation. For example, in such a case that the server side has already been activated when the server side receives the activation request, the server side may immediately transmit contents.

In this case, the server side immediately transmits either activation completion notification or notification of being already activated. As a result, the client side can immediately playback the contents transmitted from the server without playbacking the quick-playback content. In this case, the client side does not execute the process operation of step 313, and requests the contents from a head thereof in step 315.

In such a case that the server side has not been activated in the step 302, the server side starts an activation (step 303). This may be activated by employing the WOL (Wake On LAN). In the WOL, such a system is constructed that since a specific packet called as a “magic packet” is transmitted from another appliance to a network interface, a main body is activated via the network interface.

Next, when the activation is completed, activation completion notification is transmitted to the client side which activated this server (step 304). When the client side transmits the activation request to the server side in the step 312, the quick-playback content recorded on the client side is playbacked (step 313). The location of the quick-playback content is described as a URL in the indexes. Since a URL is present in the own recorder, a network address may be as a local host. When the activation completion notification is received (step 314), such a process operation for playbacking both the quick-playback content and continuous content acquired via a network in a seamless manner (namely, seamless playback) is carried out after step 315.

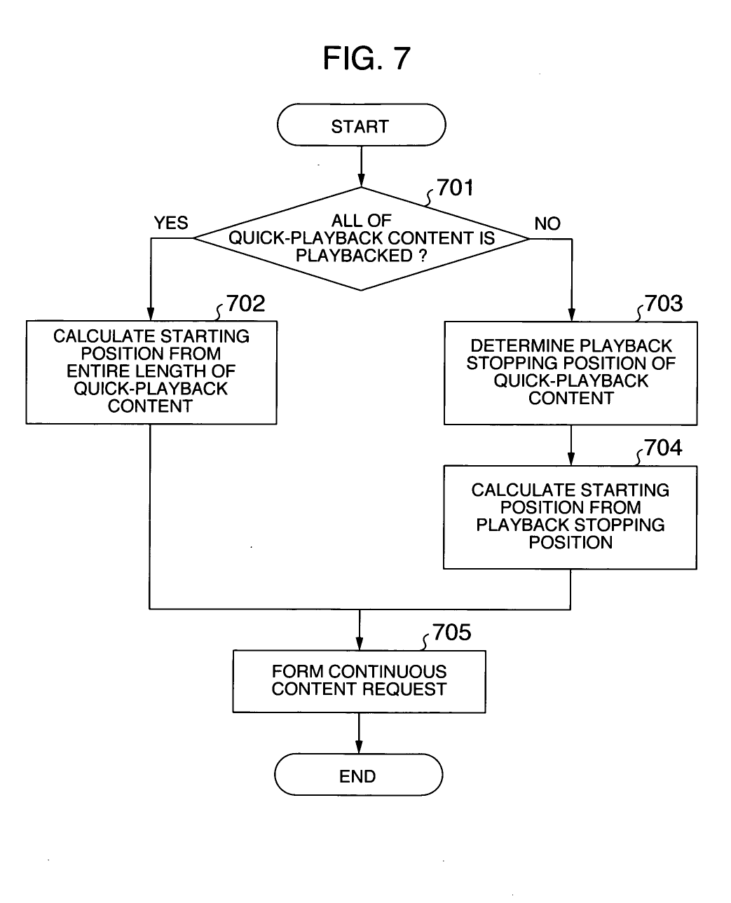

First, a continuous content request for requiring a continuation of the quick-playback content is formed (step 315). A detail of the process operation of the step 315 will be explained in FIG. 7. Next, the continuous content request is transmitted to the server side (step 316). The server side receives the continuous content request (step 306), forms the continuation of the quick-playback content from the content, and then, transmits it as continuous content (step 307). The continuous content is formed in such a way that the content is cut out based upon either a byte length from the head of the content or a time corresponding to the byte length.

When the client side receives the continuous content (step 317), the client side couples the quick-playback content to the continuous content so as to be seamless-playbacked (step 318). The seamless playback operation is such a process operation that originally one content subdivided into two contents is playbacked as a single content. When a playback operation of content is performed, especially as to picture data, all of these picture data need to be expanded to a main memory. In general, several seconds of data which are required for a playback operation are sequentially read out to be playbacked, so that a reading source may be changed in order to perform a seamless playback operation.

FIG. 4 shows a flowchart for measuring the activation time of step 201. When a power supply of a recorder is turned ON, hardware thereof is activated (step 401). Next, an operating system (OS) is activated (step 402). When the operating system is activated, or activated to some extent, either application software or software similar to this application software may be activated. As a result, application software for measuring an activation time is activated so as to commence a measuring operation of this activation time (step 403).

Next, various sorts of application software are activated (step 404). When all of necessary software is activated, the activation is completed (step 405). At this time, the measuring application software accomplishes the measuring operation (step 406). It should be noted that in step 405, the preparation for transmitting contents via the network must be completed.

Next, an activation time is calculated (step 407). When the activation time is calculated, such a time for activating both the hardware and the operating system is added to the measured activation time. Since there are some cases that times for activating hardware as well as operating systems cannot be measured, the times may be alternatively and previously set when being shipped.

If an activation time as to either hardware or an operating system can be measured, then a measured time may be employed as the above-described value. Also, instead of an activation time, an arrangement for employing a common value may be employed. For instance, assuming now that an apparatus of a level 1 is 5 seconds and an apparatus of a level 2 is 10 seconds, level values which are set at shipment may be employed as activation times.

FIG. 5 is an explanatory diagram of indexes. In this example, 5 contents are shared by plural recorders. A contents number 501 is applied to each of these 5 contents, and contents names are indicated in 502, 503 indicates URLs of the contents, and 504 is URLs of quick-playback contents corresponding thereto. In this example, while a network address becomes “localhost”, this network address indicates that this network address is present in a recorder for holding an index, 505 shows lengths of the quick-playback content.

FIG. 6 is a display example of an index selection (step 311). Numeral 601 shows a screen of a television, or the like, numeral 602 indicates names of contents, numeral 603 represents recording times of contents, numeral 604 shows day/times when contents are recorded, and numeral 605 represents genre of contents. Numeral 606 is a button area used to display detailed information of contents. While numeral 606 is selected, such a button as 608 is displayed. At this time, a decision button of 609 is also displayed, and when the decision button of 609 is depressed, detailed information is displayed. Numeral 607 indicates a focus capable of selecting contents by being moved upper/lower directions. When a playback button of a remote controller is depressed during a focusing operation, relevant contents are playbacked.

FIG. 7 is a flowchart for indicating detailed operations of the continuous contents request forming step 315. First, a judgement is made as to whether or not all of quick-playback content is playbacked by setting a recorder, or the like (step 701). When all of the quick-playback content is playbacked, since a content continued to it is requested, a starting position is calculated based upon a length of a quick-playback content (step 702). A starting position of a content is given as follows: That is, for example, assuming now that when a length of all of the content is equal to 100, a length of a quick-playback content is equal to 5, the starting point of the content becomes 6.

On the other hand, in the case that a playback operation of a quick-playback content is stopped in a half way, a playback stopping position of the quick-playback content is determined (step 703). The playback stopping position is set to a longer portion then such a time required to acquire a content from the server side. Next, a starting position is calculated from the playback stopping position (step 704). Similar to step 702, the starting position is set just after the playback stopping position. Next, a continuous contents request is formed from the calculated starting position (step 705). As to the continuous contents request to be formed, a detailed explanation thereof will be explained with reference to FIG. 8.

The continuous contents request is constituted by at least URL 801 of a content, and either a starting time (802) of the content in the unit of byte, or a starting time (803) of the content in the unit of time. If 802 and 803 indicate the same position, then both these starting times 802 and 803 may be described. A URL of a content is equal to the URL 503 of the content. The starting position of the content designates a position just after the byte position, or the time position when the playback operation of the quick-playback content is ended. In FIG. 8, the playback operation of the quick-playback content is ended just before either 48325949 bytes or 15.5 seconds. It should be noted that if the starting position of the content is set to either 0 byte or 0 second, then the continuous contents request becomes such a normal contents request whose playback operation is commenced from the head.

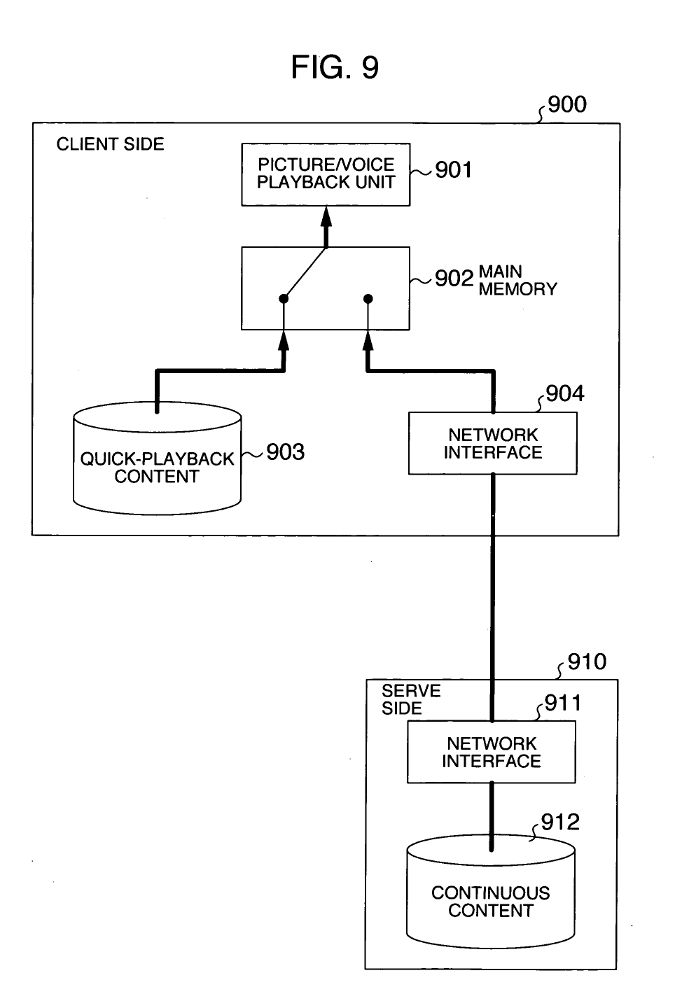

FIG. 9 is a diagram for indicating a data flow when contents and quick-playback content are playbacked. Numeral 900 shows a client-side recorder, and numeral 910 indicates a server-side recorder. When a playback operation of the content is designated, first of all, the quick-playback content is read from the client-sided recording area 903 to the main memory 902, and then, are playbacked by a picture/voice playback unit 901. When the reading operation is reached to either a terminal or a stopping position of the quick-playback content, the reading designation is switched to the continuous content. The continuous content is read from the server-sided recording area 912 via the network interface 11 and the network interface 904 to the main memory 902, and is connected to the terminal of the quick-playback content on the main memory 902, and then, are playbacked by the picture/voice playback unit 901 subsequent to the quick-playback content.

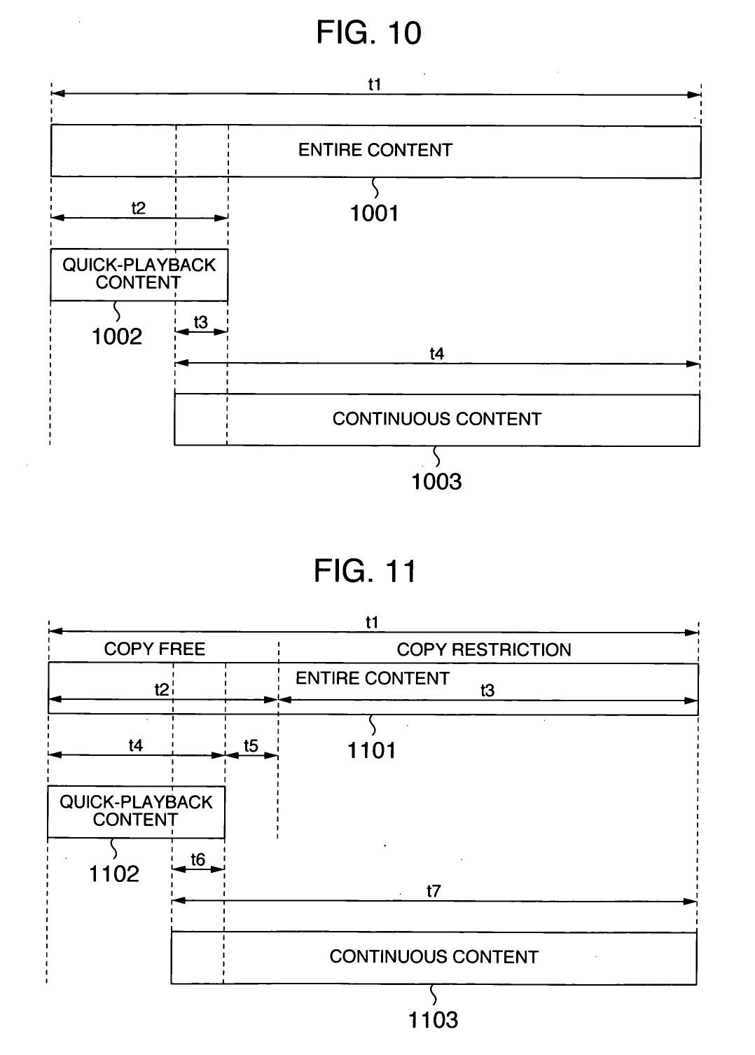

FIG. 10 is a diagram for indicating a relationship among an entire portion of content, quick-playback content, and continuous content in view of lengths thereof. It should be understood that the lengths correspond to byte lengths, or times, and therefore, similar diagrams are produced in any one of these cases. Numeral 1001 indicates the entire content, the length of which is “t1.” Numeral 1002 shows the quick-playback content, the length of which is “t2.” Numeral 1003 shows the continuous content, the length of which is “t4.” In this diagram, an overlapped portion “t3” is present in the entire content 1002 and the continuous content 1003. The overlapped portion t3 is employed as a temporal spare until the continuous contents are acquired.

For instance, if the continuous content is reached to the client-sided recorder at a time instant when the playback operation of the quick-playback content is ended, then the overlapped portion t3 may also be nearly equal to 0. However, in the case that contents are transmitted/received via a network, a buffer is normally provided in order to absorb a fluctuation of a communication speed of the network. This buffer corresponds to “t3.” It should be noted that as this buffer, a buffer having another purpose may be employed.

Similar to FIG. 10, FIG. 11 is a diagram for indicating a relationship among an entire portion of content, quick-playback content, and continuous content in view of lengths thereof in such a case that contents own a copy restriction. It should also be noted that as to content 1101, a head portion becomes a copy free, and a copy restriction is made after a time “t2” has elapsed.

In such a case, quick-playback content 1102 must be set by t2>t4. If t2<t4, then there are some cases that the quick-playback content cannot be transmitted to the client side due to copy restriction. Also, since t2 is such a time which is determined by a forming source of a content, this time “t2” may be defined by such a value that a more or less temporal spare may be given to a time “t5.” For instance, when t2=120 seconds, there is a high possibility that all of activation times for the normal appliances can be covered, times “t6” and “t7” correspond to the times “t3” and “t4” of FIG. 10.

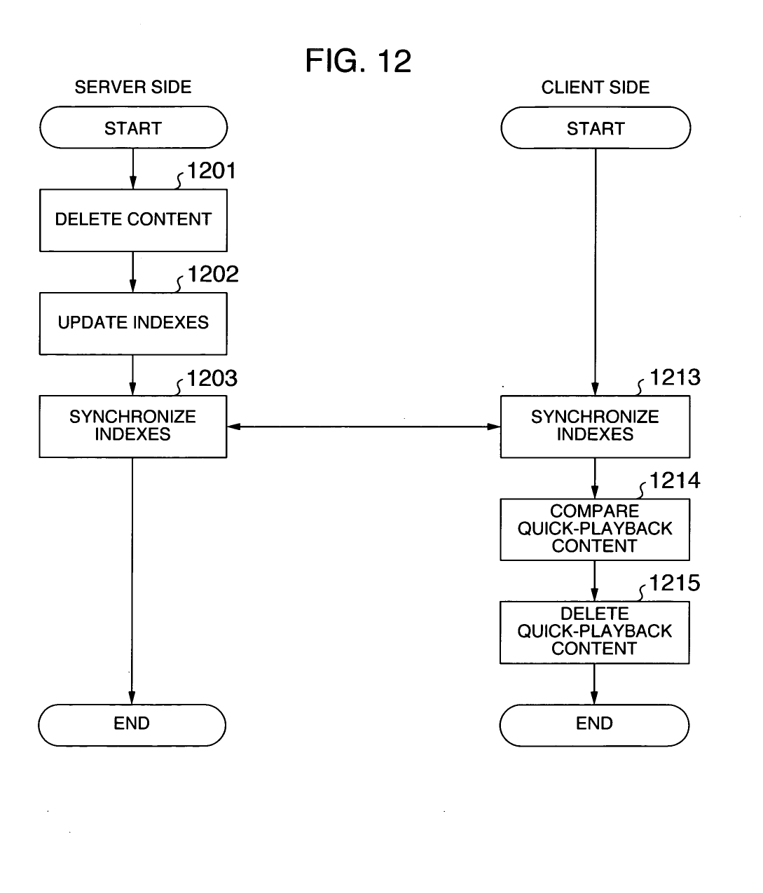

FIG. 12 is a flowchart for explaining operations executed in the case that a content is deleted on the side of the server. When the content is deleted on the server side (step 1201), the content is deleted from the contents area. Next, the indexes are updated on the server side (step 1202). The URL of the deleted content is deleted from the indexes, or such an information that the content has been deleted is added to the indexes.

Next, the indexes on the server side are synchronized with the client side (steps 1203 and 1213).

When the client side compares the indexes with the quick-playback content, and then, confirms that a quick-playback content which is not described in the indexes is present, or such a content whose deletion has been described in the indexes is present (step 1214), the client side deletes the relevant quick-playback content from the recording area (step 1215).

Since the quick-playback content is held on the respective recorders in the above-described manner, there is such an effect that the content can be immediately playbacked by the recorder on the client side without waiting for completion of the activation of the server-sided recorder. Also, since the length of the quick-playback content is selected to be approximately the activation time of the server-sided recorder, there is another effect that the recording area on the client-sided recorder can be saved.

### Second Embodiment

Next, a description is made of a contents sharing apparatus according to a second embodiment of the present invention. A different point from the first embodiment is given as follows: That is, a quick-playback content is held by another recorder; and when a playback operation is stopped, a content located in the vicinity of the stop position is employed as a quick-playback content. It should be understood that such a recorder which holds a quick-playback content is referred to as a quick-playback content holding recorder hereinafter.

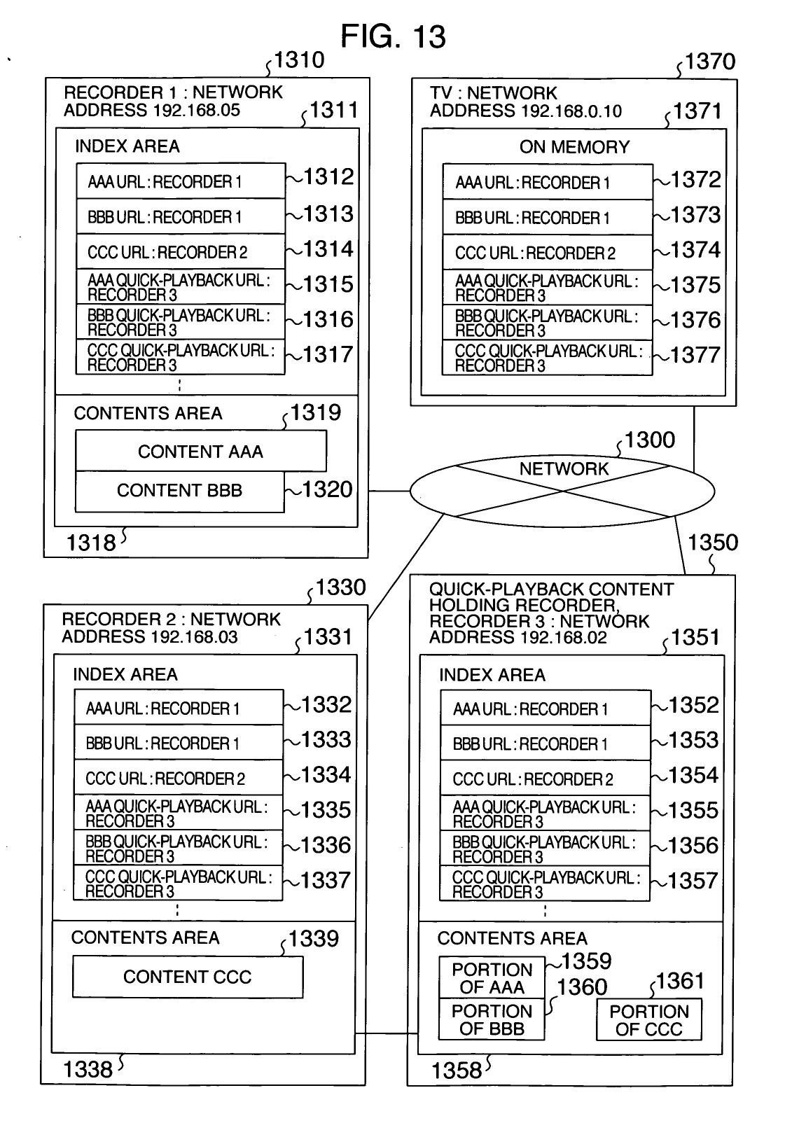

FIG. 13 is a diagram of showing an entire arrangement of the contents sharing apparatus of the second embodiment. A different point from FIG. 1 is given as follows: That is, an appliance 1370 without having an area for holding contents has been connected to the network 1300. Numerals 1310, 1330, and 1350 show recorders which share contents via the network 1300. Numeral 1370 is a television which shares the contents via the network 1300, and owns such a different point from the recorders 1310, 1330, 1350 that the television 1370 does not own an area for holding contents. It should also be noted that a television and a recorder explained in this example are basically equivalent terminals. When the appliance 1370 owns an area for holding a quick-playback content, this appliance 1370 has an arrangement similar to that of the recorder 1310, and a difference between these appliances is that a main body of a content is not held. Also, in this arrangement, since the recorder 1350 is such a recorder whose activation time is fast, or which is continuously activated, this recorder 1350 owns a larger number of quick-playback contents than that of other recorders as a quick-playback content holding recorder having quick-playback contents.

Numeral 1311 shows a recording area which holds URLs of contents. Numerals 1312 to 1314 indicate indexes which show “URLs”, namely locations of content AAA, content BBB, and content CCC. For instance, in the index 1312, it can be seen that the content AAA can be acquired from the recorder 1. It should also be noted that the URL of 1312 is simply expressed, and alternatively may be represented in such a hierarchical form as a generally used URL. Also, a file name and other information may be alliteratively described. Numerals 1315 to 1317 show URLs used to playback quick-playback contents of the content AAA, the content BBB, and the content CCC. Numeral 1318 indicates a contents area for recording of main body of contents. Numerals 1319 and 1320 represents contents.

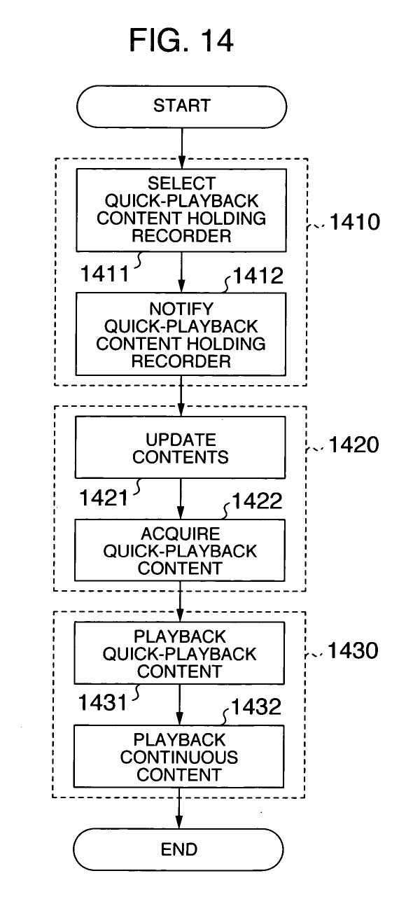

Numeral 1330 indicates a recorder 2 having a similar arrangement of the recorder 1 (1310). Numeral 1350 shows a recorder 3 having a similar arrangement of the recorder 1 (1310). However, in this example, quick-playback contents have been held in the contents area 1358. For instance, in the case that an activation speed of the recorder 3 is faster than those of the recorder 1 and the recorder 2, or a time during which the recorder 3 is activated is usually longer than those of the recorder 1 and the recorder 2, there is a possibility that the recorder 3 (1350) has the shortest time during which the television 1370 issues to acquire a content and thereafter actually acquires the content. As a result, if the recorder 3 is selected as a quick-playback content holding recorder and hold a quick-playback content, then the quick-playback content can be firstly playbacked from the recorder 3 after a user requests a playback operation, and subsequently, the quick-playback content can be playbacked. It should also be noted that the content main body may be held in the contents area 1358. A selection of the quick-playback content holding recorder will be explained in 1411 of FIG. 14.

Numeral 1370 shows a television without having an area for recording contents. URLs 1372 to 1374 of the respective contents, and head URLs 1375 to 1377 have been held in a memory 1371. The memory 1371 may be substituted by an HDD.

In the above-described arrangement, for example, when the content CCC is newly playbacked on the recorder 1 (1310), since the content main body is not present in the content area 1318, this content main body is required to be acquired from another appliance. When referring to the indexes 1314, the URL of the content CCC becomes the recorder 2 (1330), and a request for transmitting the content is issued via the network. At the same time, since the URL (1361) of the head portion of the content CCC corresponds to the recorder 3, the head portion (1361) of the content CCC is requested to the recorder 3. The recorder 3 transmits the head portion 1361 of the content CCC to the recorder 1, and after the recorder 1 receives the head portion (1361), the recorder 1 playbacks the content CCC. Also, when the recorder 1 receives the content which is requested to the recorder 2, this recorder 1 playbacks the content head portion (1361) and the content main body (1339) in a seamless manner. It should also be noted that when a restarting operation in a half may be executed (will be explained later), a half way portion of the content is held as the quick-playback content is held in addition to the above-explained content head portion. At this time, there are some case that plural pieces of quick-playback contents are held with respect to a single content.

Next, a description is made of a basic flow operation of the second embodiment with reference to FIG. 14. The basic flow operation is mainly subdivided into 3 flow operations. A first flow operation is a selecting step 1410 of a quick-playback recorder. This selecting step 1410 may be executed only one time, but may be alternatively carried out plural times in response to an instruction of a user, or at periodic timing. A next flow operation corresponds to a previous sharing step 1420 is executed at such a timing when content is newly recorded, or at periodic timing. A next flow operation corresponds to a playbacking step 1430 of the content. In this step 1430, a playback operation of the content is carried out.

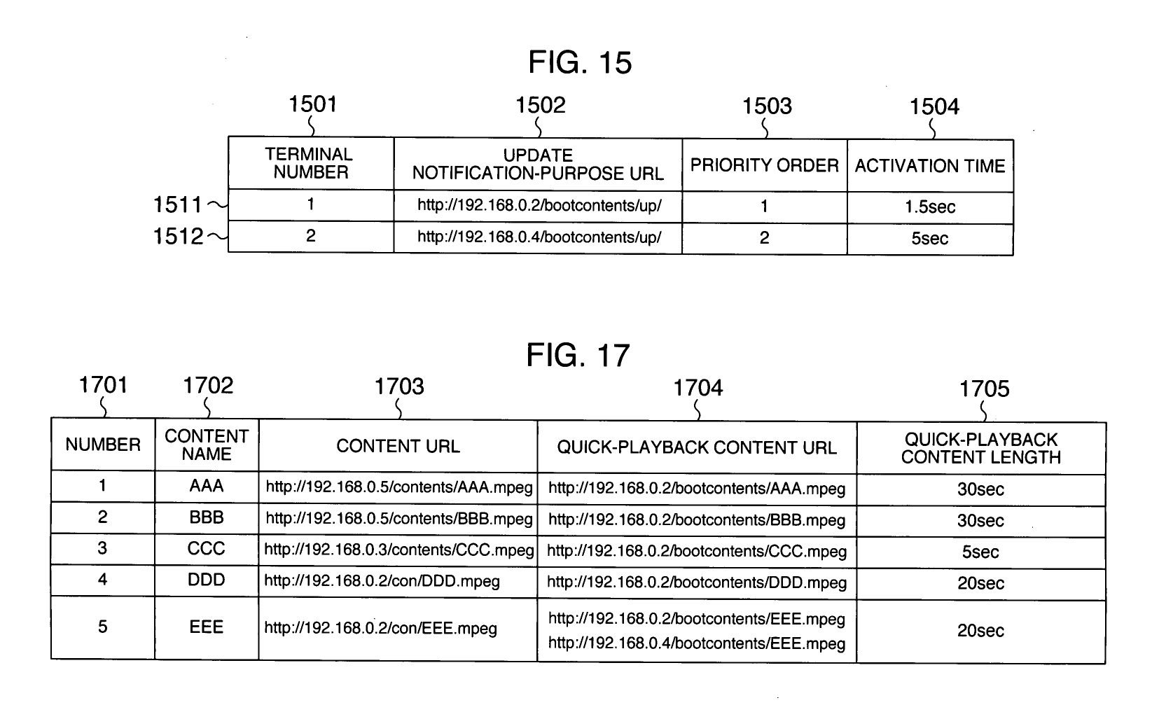

The basic flow operations will now be explained in detail. First, in the step for selecting the quick-playback content holding recorder, a recorder which should hold the quick-playback content is selected from the recorder capable of recording the plural contents (step 1411). As the selection base, an activating speed is fast; a ratio of time during which a recorder is activated within a day is long; and power consumption is low. At least one recorder is selected as the quick-playback content holding recorder based upon these parameters. Next, the selected result is notified to other recorders (step 1412). The recorder which receives the selected result holds this result as a table shown in FIG. 15. Next, when the content is updated by that the recorder performs the recording operation, the recorder updates a content list (step 1421). The content list is shared by other recorders and the television.

Next, the quick-playback content holding recorder acquires a quick-playback content (step 1422). There are two acquision methods. As one acquisition method, the recorder which has updated the content list by recording the content notifies the updating operation of the content to the quick-playback content holding recorder by employing an update notification-purpose URL (will be explained in numeral 1502). The quick-playback content holding recorder acquires the quick-playback content based upon the notification. The second method is such a method that when the quick-playback content holding recorder senses an addition of a content by updating the content list, this recorder acquires the quick-playback content corresponding thereto. Although the corresponding relationships between the contents and the quick-playback contents are similar to the corresponding relationship shown in FIG. 5, localhost of 504 is changed into a network address of a recorder which holds the contents. Also, when deletion of a content is detected in step 1421, the quick-playback content corresponding thereto is discarded in step 1422.

Next, when either a television on a recorder tries to playback a content, a quick-playback content is playbacked via the network (step 1431). In this step 1431, a transmission of a content is requested with respect to other recorders at the same time. Next, when the content is reached from such a recorder which holds the content main body, a playback operation is carried out subsequent to the content under playback in step 1431 (step 1432). Thus the process operation is accomplished. It should be noted that the content under playback in step 1431 may be interrupted in a half way. Also, while the content is playbacked, the continuous content may be acquired. Alternatively, both the quick-playback content and the content main body may be temporarily acquired at the same time.

Blocks 1410, 1420, and 1430 need not be always executed in this order, but may be repeatedly carried out in an independent manner.

Next, a description is made of a table containing selected results which are held by the respective recorders with reference to FIG. 15. Numeral 1501 shows a terminal number of this table. In this table, only terminal numbers 1 and 2 are present. Nnumeral 1502 indicates a content update notification-purpose URL to a quick-playback content holding recorder. An update of a content can be notified by this URL. Numeral 1503 shows a priority order of a quick-playback content holding recorder. For example, if it is so set that only one content update is notified, then this content update is notified to the terminal number 1511 having the high priority order. If it is so set that two content updates are notified, then the content updates are notified with respect to the terminal numbers 1511 and 1512. Numeral 1504 indicates an activation time of a quick-playback content holding recorder.

A difference between this time and an activation time of a recorder which holds a content main body constitutes a length of such a content which should be held as a quick-playback content. For example, it is so assumed that the activation time of the terminal number 1511 is 1.5 seconds and an activation time of a recorder which holds a certain content EEE is 20 seconds, there are 18.5 seconds after the quick-playback content holding recorder has been activated until the recorder holding the content EEE is activated. As a consequence, if the length of the quick-playback content is longer than, or equal to 18.5 seconds, then the activation of the recorder which holds the content can be completed and can transmit the content while the quick-playback content is playbacked.

If the recorder holding the content transmits a continuous content, then the user can view the content after 1.5 seconds. It should also be noted that the above-described activation time also contains a setting time of a network. Also, since a buffer required to transmit/receive a content and encode/decode a content is not considered, the above-explained calculated time must contain times required for considering these operations. It should also be understood that a device for notifying a content update may alternatively utilize a device for sharing either a content main body or a content list. For instance, the content update may be sensed by updating the content list so as to acquire a quick-playback content.

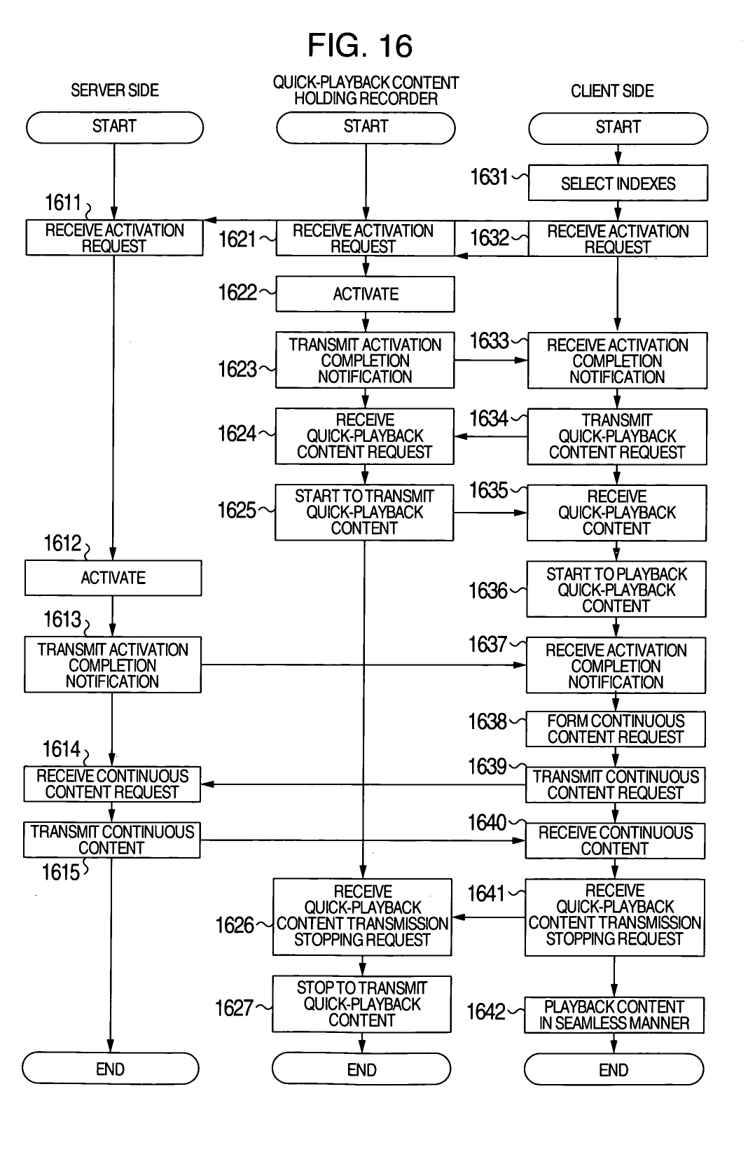

Next, a description is made of flow operations in the case that a content is playbacked with reference to FIG. 16. It is so assumed that indexes of contents have been shared as an initial condition. Also, a server side indicates a terminal such as a recorder which holds a content, and a client side shows a terminal such as a television by which the content is viewed.

When the process operation is commenced, the client side selects index of content to be playbacked (step 1631). Details of the indexes will be explained in FIG. 17. Next, the client side transmits an activation request via the network with respect to the server side and the quick-playback content holding recorder (step 1632). The quick-playback content holding recorder and the server side receive the activation requests respectively (steps 1621 and 1611). In such a case that the server side has already been activated, since the quick-playback content is not playbacked, the server side immediately transmits activation completion notification, and the client side directly acquired the content from the server side.

Next, the quick-playback content recorder is activated (step 1622), and then, transmits activation completion notification to the client side (step 1623). When the client side receives the activation completion notification (step 1633), the client side firstly transmits a quick-playback content request to the quick-playback content holding recorder so as to acquire a content from the quick-playback content holding recorder (step 1634). When the quick-playback content holding recorder receives the quick-playback content request (step 1624), this recorder commences to transmit the quick-playback content (step 1625). When the client side receives the quick-playback content (step 1635), the client side starts to playback the quick-playback content (step 1636). It should also be noted that the steps 1634, 1624, 1625, and 1635 may be alternatively executed in a repetition manner while the quick-playback content is playbacked.

Next, when the server side is activated (step 1612), the server side transmits activation completion notification to the client side (step 1613). When the client side receives the activation completion notification (step 1637), the client side forms a request of a continuous content (step 1638). A continuous content implies such a content which is playbacked from a continuation of a quick-playback content. In such a case that, for instance, a length of a quick-playback content is defined from a head up to “k” bytes, a content from a (k+1)-th byte is requested as this continuous content. It should also be understood that the continuous content need not be started from the end of the quick-playback content, but the quick-playback content may be partially overlapped with the continuous content.

Next, the client side transmits a continuous content request (step 1639). When the server side receives the continuous content request (step 1614), the server side transmits the continuous content (step 1615). When the client side receives the continuous content (step 1640), the client side transmits a transmission stop request of the quick-playback content (step 1641). The process operation of step 1641 need not always transmit the stop request, but may alternatively request to cut, for example, a connection of a network. When the quick-playback content holding recorder receives the transmission stop request of the quick-playback content (step 1626), this recorder stops to transmit the quick-playback content (step 1627). The client side playbacks the continuous content received in the step 1640 in continuation with the quick-playback content (step 1642). It should also be understood that step 1642 may be alternatively executed before step 1641. The above-described playback flow operations are accomplished.

Next, an index table will now be explained with reference to FIG. 17.

Numeral 1701 shows a content number on a list. In this list, there are content numbers 1 through 5. Numeral 1702 indicates names of contents. Numeral 1703 indicates URLs of a server side so as to acquire the contents. Numeral 1704 shows URLs used to acquire quick-playback contents. Numeral 1705 shows times for quick-playback contents, for example, in the case of the content AAA, a time for the quick-playback content can be acquired by 30 seconds in maximum.

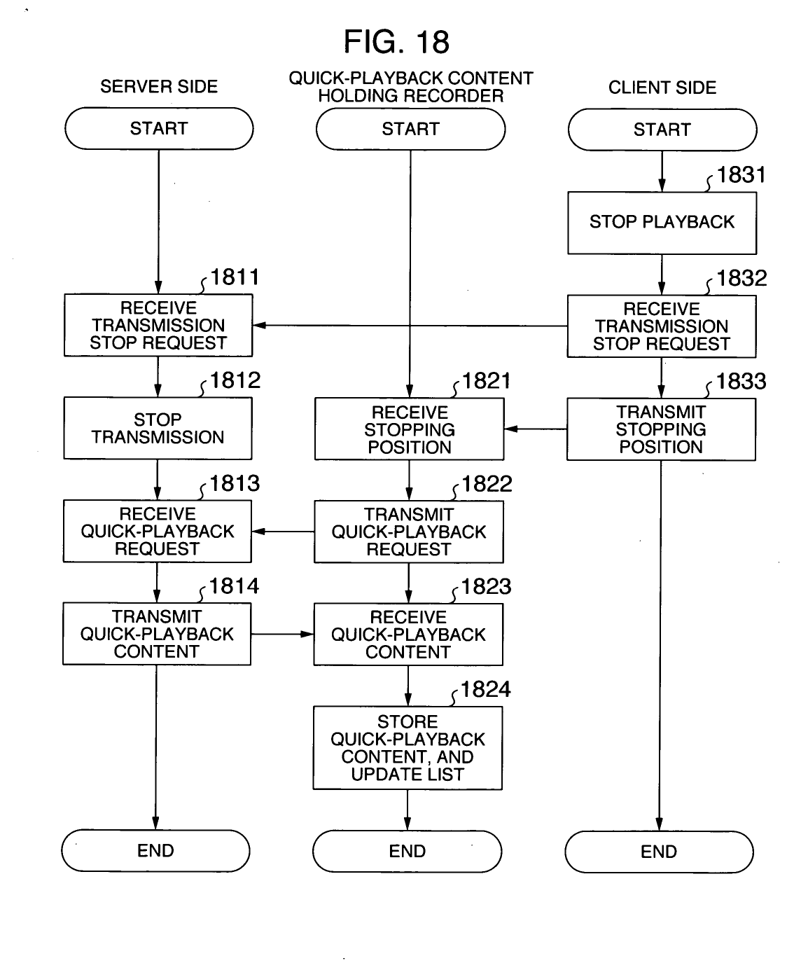

Next, referring now to a flowchart of FIG. 18, a description is made of flow operations as to such a quick-playback content which supports stopping and restarting of a playback operation of a content. First, the playback operation is stopped on the client side (step 1831). Next, the client side transmits a transmission stop request to the server side (step 1832). When the server side receives a transmission stopping request (step 1811), the server side stops the transmission (step 1812). Also, the client side transmits a position where the playback operation is stopped to the quick-playback content holding recorder (step 1833). When the quick-playback content holding recorder receives the stopping position (step 1821), the server side transmits a quick-playback content request to the server side (step 1822).

The quick-playback content request corresponds to either a content request for an initial time of the server side from the stopping position or a content request for an initial time of the server side before/after the stopping position. Upon receipt of the quick-playback content request (step 1813), the server side transmits a content having a requested length as the quick-playback content to the quick-playback content holding recorder (step 1814), and the transmitted quick-playback content is received in the quick-playback content holding receiver (step 1823). The received content is stored in the content area, and the list of the held quick-playback contents is updated (step 1824). It should also be understood that the transmission destination of the stopping position in the step 1833 may be alternatively transmitted to the server side. In this alternative case, the server side transmits the stopping position to the quick-playback content holding recorder. The quick-playback content holding recorder continuously executes the process operations after step 1822.

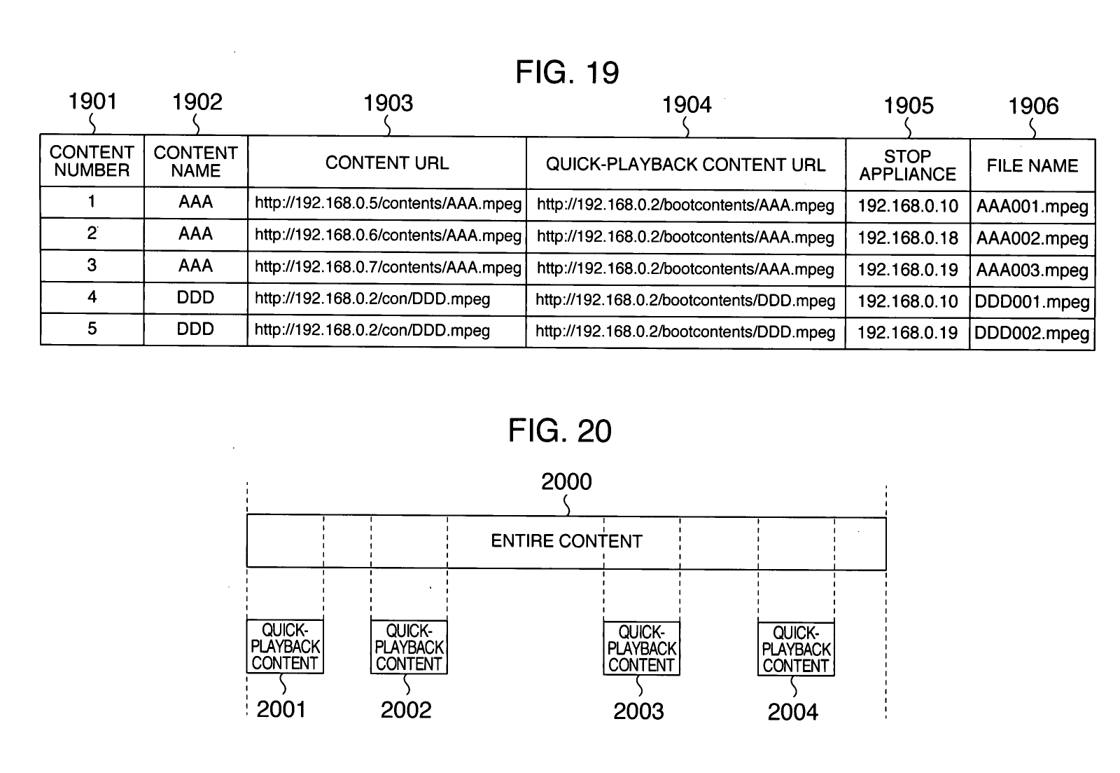

Next, the list of the quick-playback contents which are updated in step 1824 will now be described with reference to FIG. 19. Numerals 1901 to 1903 are similar to the above-described reference numerals 1701 to 1703. Numeral 1904 shows quick-playback contents URLs. When the client side accesses this URL, the client side can acquire substance 1906 of a corresponding quick-playback content by being compared with an address 1905 of the client side. For instance, when a certain appliance accesses the quick-playback URL 1904, if there is only one quick-playback content, then a content corresponding to the URL can be transmitted, whereas when there are plural quick-playback contents, a quick-playback content corresponding to a stopping appliance 1905 is transmitted. Also, as to an acquisition request issued from an appliance which is not described in a list of stopping appliances, contents from a head are transmitted.

Next, a relationship between entire contents and quick-playback contents will now be explained with reference to FIG. 20. Numeral 200 shows the entire contents. Numerals 2001 to 2004 indicate quick-playback contents. More specifically, numeral 2001 shows a quick-playback content, and numerals 2002 to 2004 shows intermediate restarting contents. Also, in the case that respective contents are not overlapped with each other, two sets of the contents are recorded at the same time, and if one of these two contents is subdivided as explained in FIG. 20, then quick-playback contents can be formed. In this case, a total number of tuners which are used at the same time may be selected to be 2.

As previously explained, since the quick-playback contents are held by a recorder which is different from the recorder which holds the content main body, there is such an effect that a time duration after a playback operation is instructed on the client side until the playback operation is actually commenced can be shortened. Also, there is another effect that since the stopping position is notified to the quick-playback content holding recorder and contents in the vicinity of the stopping position are acquired from the server side, the stopped contents can be playbacked and restarted at a high speed.

It should be further understood by those skilled in the art that although the foregoing description has been made on embodiments of the invention, the invention is not limited thereto and various changes and modifications may be made without departing from the spirit of the invention and the scope of the appended claims.

1. A contents sharing apparatus having a function for sharing contents via a network, comprising:
means for holding a time required to activate the contents sharing apparatus;
means for previously transmitting a content corresponding to the time for activation to another apparatus;
means for forming and updating indexes of contents held in the contents sharing apparatus; and
means for sharing the indexes with another contents sharing apparatus, wherein
the content corresponding to the time required for the activation is previously transmitted to another contents sharing apparatus.

2. The contents sharing apparatus according to claim 1, further comprising:
means for measuring time for activating said contents sharing apparatus.

3. The contents sharing apparatus according to claim 1, further comprising:
means for forming and updating indexes of the content corresponding to the time required for the activation.

4. The contents sharing apparatus according to claim 3, further comprising:
means for holding a network address of the content in said indexes.

5. The contents sharing apparatus according to claim 3, wherein
the indexes of the content corresponding to time required for activation are contained in an area where the indexes of the contents held in said contents sharing apparatus are expanded so as to be managed.

6. The contents sharing apparatus as claimed in claim 1, wherein
in order to previously share the content corresponding to the time required for the activation with another apparatus, activation time is contained in the indexes, and another apparatus previously shares said contents by requesting the content corresponding to the activation time.

7. A contents sharing apparatus having a function for sharing contents via a network, comprising:
means for acquiring indexes from another contents sharing apparatus;
means for previously acquiring a portion of content from another contents sharing apparatus; and
means for acquiring a continuation of contents which have been previously acquired from another contents sharing apparatus having contents, wherein
when a content designated by said indexes is playbacked, the previously acquired content is playbacked, and a continuation of the content subsequent to the previously acquired content is playbacked.

8. The contents sharing apparatus according to claim 7, wherein
said portion of said previously acquired content corresponds to a content having a length corresponding to an activation time provided by the contents sharing apparatus.

9. The contents sharing apparatus as claimed in claim 7, wherein
said portion of said previously acquired contents corresponds to such a content which is indicated as a content which should be previously acquired in the indexes of the contents shared by the contents sharing apparatus.

10. The contents sharing apparatus according to claim 7, wherein
since a length corresponding to a content activation time acquired from the contents sharing apparatus is designated while the contents are acquired, a portion of the contents is previously acquired.

11. The contents sharing apparatus as claimed in claim 7, wherein
when the contents are playbacked, an activation of another contents sharing apparatus is instructed, the previously acquired content is playbacked, and a continuation of the content subsequent to the previously acquired content is playbacked.

12. A contents sharing method in a contents sharing apparatus having a function for sharing contents via a network, comprising:
a step for forming, or updating indexes of contents held in the contents sharing apparatus in order that the indexes of the contents are shared by another contents sharing apparatus; and
a step for previously transmitting a content corresponding to an activation time of the contents sharing apparatus; wherein:
contents corresponding to the indexes are transmitted.

13. A contents sharing method in a contents sharing apparatus having a function for sharing contents via a network, comprising:
a step for previously acquiring a portion of a content from another contents sharing apparatus;
a step for designating a content which should be playbacked based upon indexes of contents held in the contents sharing apparatus so as to instruct a playback operation of the content;
a step for playbacking the content previously acquired in response to the instruction of the playback operation; and
a step for acquiring a continuation of the previously acquired content from another contents sharing apparatus having the contents which should be playbacked, wherein
a continuation of the content subsequent to the previously acquired content is playbacked.

14. The contents sharing apparatus according to claim 1, further comprising:
means for selecting a specific contents sharing apparatus from said other contents sharing apparatus as a sharing apparatus which holds a content corresponding to a time required for an activation corresponding to a portion of the content.

15. The contents sharing apparatus according to claim 14, wherein
said means for selecting the specific contents sharing apparatus corresponds to a method for selecting an apparatus, the activation time per day of which is longer than that of other contents sharing apparatus.

16. The contents sharing apparatus according to claim 14, wherein
said means for selecting the specific contents sharing apparatus corresponds to a method for selecting an apparatus, the activation speed of which is faster than that of other contents sharing apparatus.

17. The contents sharing apparatus according to claim 14, wherein
said means for selecting the specific contents sharing apparatus includes means for notifying the selected contents sharing apparatus to other contents sharing apparatus.

18. The contents sharing apparatus according to claim 14, further comprising:
means for notifying an acquisition of a content to the selected contents sharing apparatus when the content is acquired.

19. The contents sharing apparatus as claimed in claim 1, further comprising:
means for sensing that a content is added to said indexes; and
means for previously acquiring a head portion of said sensed content.

20. The contents sharing apparatus according to claim 14, further comprising:
means for receiving notification of said selected contents sharing apparatus; and
means for describing a network address in said indexes, said network address acquiring a portion of the content previously acquired from said selected contents sharing apparatus.

21. A contents sharing apparatus having a function for sharing contents via a network, comprising:
means for acquiring indexes from another contents sharing apparatus;
means for acquiring a portion of content from another contents sharing apparatus to playback said portion of the acquired content; and
means for acquiring contents from another contents sharing apparatus to playback the acquired content subsequent to said portion of the content.

22. The contents sharing apparatus as described in claim 21, further comprising:
means for interrupting the playback of said content; and
means for transmitting information of the interrupted portion to another contents sharing apparatus.

23. The contents sharing apparatus according to claim 1, further comprising:
means for receiving the information of the interrupted portion from another contents sharing apparatus; and
means for acquiring a content in a vicinity of the interrupted portion from another contents sharing apparatus.

24. The contents sharing apparatus according to claim 1, further comprising:
means for detecting an interruption of a transmission of a content; and
means for transmitting an instruction for acquiring the content in a vicinity of the detected portion to another contents sharing apparatus.
